(19) United States
(12) Patent Application Publication
(10) Pub. No.: US 2012/0263099 A1
(43) Pub. Date: Oct. 18, 2012

(54) INTEGRATED REPEATER HAVING APPLICATION TO INTERNET NETWORK AND COMPRESSION ALGORITHM

(75) Inventors: Eun Chul Lee, Seongnam (KR); Se Young EUN, Anyang (KR)

(73) Assignee: INTELRA.INC., Seongnam (KR)

(21) Appl. No.: 13/533,995

(22) Filed: Jun. 27, 2012

Related U.S. Application Data
(63) Continuation-in-part of application No. PCT/KR2010/008751, filed on Dec. 8, 2010.

(30) Foreign Application Priority Data
Dec. 29, 2009 (KR) 10-2009-0132639

(51) Int. Cl. H04W 88/04

(52) U.S. Cl. 370/315

(57) ABSTRACT

There is disclose an integrated repeater system including a master unit (MU) to multiplex and transmit a first signal received from a first equipment and a second signal received from a second equipment to a frame usable for an Ethernet PHY chip; and a remote unit (RU) to demultiplex the frame received from the master unit to the first signal and the second signal and to control the first signal to be transmitted to a first terminal and the second signal to be transmitted to a second terminal.

### CROSS-REFERENCE TO RELATED APPLICATION

This is a continuation-in-part application of a pending International Application PCT/KR/2010/008751, filed on Dec. 8, 2010, which claims the benefit of Korean patent Application KR-10-2009-0132639, filed on Dec. 29, 2009, the subject matter of which are incorporated herein by reference.

### TECHNICAL FIELD

Embodiments of the invention may relate to an integrated repeater having application to an internet network and compression algorithm, more particularly, to an integrated repeater system that includes a master unit (MU) capable of multiplexing a first signal and a second signal into a frame useable for Ethernet PHY and transmitting the multiplexed frame to each of remote units (RU) installed in a radio shadow area of a building or an outdoor via a UTP cable, to utilize an installed infrastructure environment and to enhance a communication service quality.

### BACKGROUND

Generally, for providing of an internet service in a building, an internet signal is transmitted from external internet equipments or a central computer processor unit of a building via an UTP cable and the transmitted signal is extended and distributed to the UTP cable via each distribution port of a switching hub, to transmit the extended and distributed signals to a PC terminal of each user. After that, the internet signals input to the building are used by a plurality of users.

A single switching hub or a plurality of switching hubs may be provided in each of floors in a building. The number of the switching hubs may be variable rather than the proposed one based on the size of the building, an internal structure of the building and the number of internet users. Such a conventional internet service system continuously builds switching hubs and UTP cables to enable more users to use the internet. However, rather than the internet system using the UTP cables, auxiliary optical cables or coaxial cables capable of transmitting signals received from the external base station have to be installed in the building to provide a mobile communication service as well as the internet service to users in the building.

If building new optical cables or coaxial cables in every floor in the building to provide the mobile communication service, quite a construction cost and construction time will be taken to waste various material resources, time and human resources and also the building of the new cables such as the optical cables or coaxial cables might deteriorate internal and external beauty of the building.

Meanwhile, such the mobile communication network uses the optical cables or coaxial cable. Accordingly, such the mobile communication network requires more construction cost than the cost of the equipments required by the service.

Although both of the networks are applicable to the same building, the mobile communication network using the optical or coaxial cables and a very high speed digital communication network are connected with each other only via upper core communication network and they form independent modes at lower levels.

In other words, those mobile communication service and very high speed digital communication network have the same purposes in a single building and types of the services are completely different, although they are used together. The mobile infrastructure and the very high speed internet infrastructure share a high core network of the communication network. However, those businesses have been developing in totally different and main wire/wireless businesses are different to make those services maintain competitive relation constantly. Accordingly, those service business agents have been investing heavily in expanding their areas competitively. Unnecessary overlapping investments are continued and excessive investment interferes with the initial profit structure. As a result, there might be problems of failures in initial business processes.

Owing to those problems of the prior art, there have been demands on development of an integrated repeater system that enables an internet and communication service by transmitting an internet signal (WiFi) and a mobile communication signal (WCDMA and Wibro) simultaneously, utilizing the preinstalled infrastructure environments.

### DISCLOSURE

### Technical Problem

To solve the problems, an object of the invention is to provide a an internet network and compression algorithm, more particularly, to an integrated repeater system that includes a master unit (MU) capable of multiplexing a first signal and a second signal into a frame useable for Ethernet PHY and transmitting the multiplexed frame to each of remote units (RU) installed in a radio shadow area of a building or an outdoor via a UTP cable, to utilize an installed infrastructure environment and to enhance a communication service quality.

### Technical Solution

To achieve these objects and other advantages and in accordance with the purpose of the embodiments, as embodied and broadly described herein, an integrated repeater system includes a master unit (MU) to multiplex and transmit a first signal received from a first equipment and a second signal received from a second equipment to a frame usable for an Ethernet PHY chip; and a remote unit (RU) to demultiplex the gigabit Ethernet frame received from the master unit (MU) to the first signal and the second signal and to control the first signal to be transmitted to a first terminal and the second signal to be transmitted to a second terminal.

In another aspect of the invention, an integrated repeater system includes a master unit (MU) to multiplex and transmit a first signal received from a first equipment and a second signal received from a second equipment to a frame usable for an Ethernet PHY chip; and an expansion unit (EU) to demultiplex the gigabit Ethernet frame received from the master unit (MU) to the first signal and the second signal and to re-multiplex and transmit the demultiplexed first and second signals to the gigabit Ethernet frame; and a remote unit to receive the gigabit Ethernet frame from the expansion unit (EU), and to demultiplex the gigabit Ethernet frame to the first signal and the second signal to control the first signal to be transmitted to a first terminal and the second signal to be transmitted to a second terminal.

### Advantageous Effects

The embodiments have following advantageous effects. The integrated repeater system according to the invention may utilize UTP cables preinstalled in a building to provide an internet service to an apartment building, an office, a company or the like. Accordingly, the integrated repeater system may have an effect of transmitting a mobile communication signal and an internet signal to a building or outdoor areas simultaneously.

Furthermore, the integrated repeater system according to the invention may have an effect of efficiently providing an internet service and dual band service via an existing UTP repeater service network to remove a radio shadow area of a building or an outdoor, without embedding auxiliary optical or coaxial cables.

### BRIEF DESCRIPTION OF THE DRAWINGS

Arrangements and embodiments may be described in detail with reference to the following drawings in which like reference numerals refer to like elements and wherein:

FIG. 1 is a diagram illustrating an integrated repeater system according to an embodiment of the invention;

FIG. 2 is a diagram illustrating an integrated repeater system according to another embodiment of the invention;

FIG. 3 is a block diagram illustrating a compression algorithm of a signal that is compressed and transmitted according to the embodiment of the invention.

### BEST MODE

In an integrated repeater system according to the invention, a first equipment, a first signal and a first terminal are corresponding to each other and a second equipment, a second signal and a second terminal are corresponding to each other. For example, each of the first equipment and the second equipment may be a dual band in building system, a mobile communication base station, a DMB repeater, a sensor or a switching hub. Each of the first signal and the second signal may be a mobile communication signal, a DMB signal, a sensing signal or an internet signal. Each of the first terminal and the second terminal may be a mobile communication terminal, an internet terminal, a DMB terminal or a server.

For explanation convenience in the preset specification, the first equipment may be a mobile communication base station and the second equipment may be a switching hub. The first signal may be a mobile communication signal and the second signal may be an internet signal. The first terminal may be a mobile communication terminal and the second terminal may be an internet terminal.

Embodiments of the invention will be described in detail in reference to the accompanying drawings as follows.

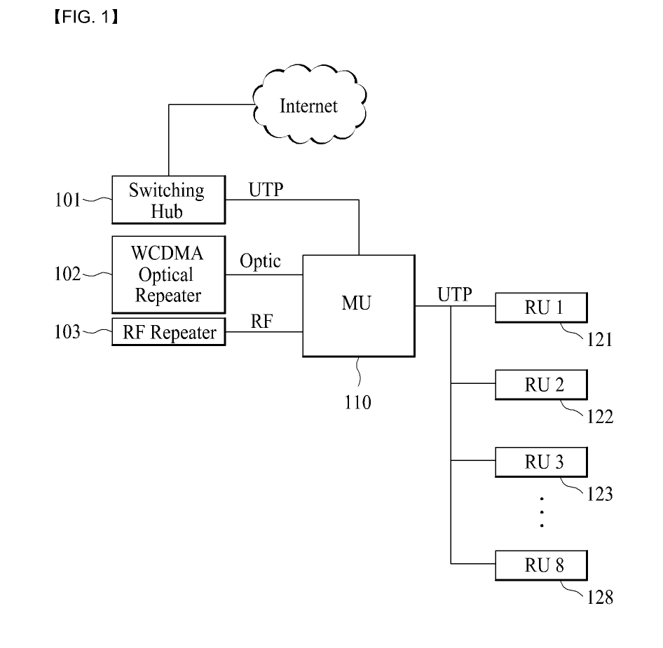

FIG. 1 is a diagram illustrating an integrated repeater system according to an embodiment of the invention.

The integrated repeater system according to the embodiment includes a maser unit (MU) 110 and a remote unit (RU) 121 to 128.

A plurality of master units (MU) 110 and a plurality of remote units (RU) 121 to 128 may be installed in a building according to a design of a person skilled in the art to which the present invention pertains. In the present specification, it is proposed for description convenience that a single mater unit (MU) 110 be installed and that an a first remote unit 121 through eighth remote unit RU 128 that composes an expanded remote unit are installed in areas of a building.

The mater unit (MU) 110 may be connected with a switching hub 101, a mobile communication base state 102 and RF repeater 103. The master unit (MU) 110 may receive an internet signal from the connected switching hub 101 via a UTP cable. Also, the mater unit (MU) 110 may receive a mobile communication signal from the connected dual band in building system 102 via an optical cable. The master unit (MU) 110 may be connected with a main hub unit of the dual band in building system 102 via the optical cable. Also, the mater unit (MU) 110 may receive a mobile communication signal from the connected RF repeater 103 via RF interfacing.

The master unit (MU) 110 may multiplex and transmit the mobile communication signal transmitted from the dual band in building system 102 or the RF repeater 103 and the internet signal transmitted from the switching hub 101 into frames useable on an Ethernet PHY chip. In this instance, the frame may be a gigabit Ethernet frame.

The master unit (MU) 110 may separate payload from the internet signal, using a fast Ethernet PHY chip, and it may compress the mobile communication signal based on a compression algorithm set for 1 Gbps transmission. Veribit compression algorithm, RateTrak compression algorithm or Optibit compression algorithm may be used as the compression algorithm. The compression algorithm may be realized by a variety of compression algorithms well-known for transmission of mobile communication signals in the art to which the invention pertains.

The master unit (MU) 110 may multiplex the internet signal and the mobile communication signal into a frame that can be used for the Ethernet PHY chip. The frame may be realized to have a MII (media independent interface) standard such as GMII, RMII, RGMII, SGMII or XGMII. For example, when the gigabit Ethernet frame may be realized in IEEE802.3 GMII standard. According to the embodiment of the invention, the gigabit Ethernet frame includes a 100 Mbps internet signal, a WCDMA (62.5 Msps×6.5 bit=406 Mbps, Compressibility=2.15) signal and a Wibro (62.5 Msps×6.5 bit=406 Mbps, Compressibility=2.15). The transmission speed of the gigabit Ethernet frame may be 912 Mbps(Data), 88 Mbps(Header, NMS Control Channel) and the gigabit Ethernet frame may match Gigabit Ethernet PHY Chip (125 Mhz, 8 bit).

The master unit (MU) 110 may insert Data Communication channel (DCC) to the Gigabit Ethernet frame and transmit the Gigabit Ethernet frame having the DCC to the remote unit (RU) 121 to 128. In other words, the master unit (MU) 110 may perform control for the state and operation of the remote unit (RU) 121 to 128 via the DCC (Data Communication Channel) inserted in the Gigabit Ethernet frame. Also, the mater unit (MU) 110 may control the remote unit (RU) 121 to 128 to receive the electric power via Power Over Ethernet (POE).

The remote units (RU) 121 to 128 may be connected with the master unit (MU) 110 via UTP cables, respectively. The remote units (RU) 121 to 128 may receive the Gigabit Ethernet frame from the master unit (MU) 110 and demultiplex the Gigabit Ethernet frame to the mobile communication signal and the internet signal. After that, the remote units 121 to 128 may control the inert signal to be transmitted to the internet terminal and the mobile communication signal to be transmitted to the mobile communication terminal. The remote units (RU) 121 to 128 may format the demultiplexed internet signal in Fast Ethernet format and the formatted internet signal to the internet terminal via Fast Ethernet PHY chip.

The remote units (RU) 121 to 128 restore the compression of the demultiplexed mobile communication signal from the Gigabit Ethernet frame. In other words, the compression of the mobile communication signal compressed and transmitted by the master unit (MU) 110 may be restored via a restoration algorithm corresponding to the compression algorithm of the master unit (MU) 110.

The remote units (RU) 121 to 128 may restore system characteristic degrade of the mobile communication signal via a digital down converter (DDC) and a digital up converter (DUC). In other words, the remote units (RU) 121 to 128 may improve the system characteristic degraded by the compression/transmission of the mobile communication signal via the digital down converter (DDC) and the digital up converter (DUC).

In addition, the remote units (RU) 121 to 128 may control the state and operation of the master unit (MU) 110 via the data communication channel (DCC) inserted in the gigabit Ethernet frame. That is, the states and operations of the remote units (RU) 121 to 128 may be controlled by the master unit (MU) 110 via the data communication channel (DCC).

The forward link of the integrated repeater system according to the embodiment of the invention is described. In contrast, a reverse link of the integrated repeater system according to the embodiment of the invention will be described as follows.

The remote units (RU) 121 to 128 may multiplex an internet signal transmitted from the internet terminal and a mobile communication signal transmitted from the mobile communication terminal in a gigabit Ethernet frame, and it may transmit the multiplexed signal to the master unit (MU) 110 via UTP cables.

The remote controls (RU) 121 to 128 may separate a payload from the internet signal via a fast Ethernet PHY chip and compress the mobile communication signal based on a preset compression algorithm fitted to 1 Gbps transmission, to multiplex the internet signal and the mobile communication signal to an IEEE802.3 GMII standard gigabit Ethernet frame.

The master unit (MU) 110 may demultiplex the gigabit Ethernet frame transmitted from the remote units 121 to 128 via the UTP cable to the mobile communication signal and the internet signal. After demultiplexing the gigabit Ethernet frame, the master unit (MU) 110 may control the internet signal to be transmitted to the switching hub and the mobile communication signal to be transmitted to the dual band in building system.

The master unit (MU) 110 may transmit the demultiplexed internet signal from the gigabit Ethernet frame to the switching hub via a fast Ethernet PHY chip in a fast Ethernet format.

The master unit (MU) 110 the compression of the demultiplexed mobile communication signal via the remote units (RU) from the gigabit Ethernet frame based on a selected restoration algorithm. The master unit (MU) 110 may restore system character degrading of the mobile communication signal via a digital down converter (DDC) and a digital up converter (DUC) and then transmit the mobile communication signal having the system characteristic degrading restored to the dual band in building system.

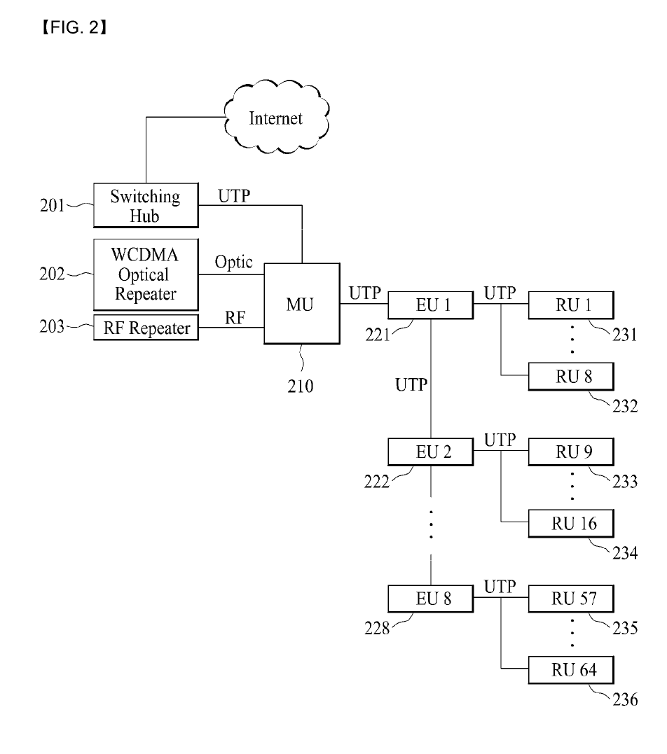

FIG. 2 is a diagram illustrating an integrated repeater system according to another embodiment of the invention.

The integrated repeater system according to this embodiment of the invention includes a master unit (MU) 110, first to eighth expansion units (EU) 221 to 228, and first to sixty-fourth remote units 236.

According to the embodiment of the invention, the first expansion unit (EU) 221 to the eighth expansion unit (EU) 228 may be sequentially connected with the master unit (MU) 210 in serial. Accordingly, each of the first to eighth expansion units 221 to 228 may be employed as a repeater capable of expanding a transmission period of a signal. As shown in FIG. 2, eight remote units are connected with each of the first to eighth expansion units (EU) 221 to 228 via UTP cables.

The master unit (MU) 210 may demultiplex a mobile communication signal received from a dual band in building system and an internet signal received from a switching hub to a gigabit Ethernet frame, to transmit the demultiplexed gigabit Ethernet frame internet signal to the first to eighth expansion units (EU) 221 to 228.

The master unit (MU) 110 may be RF-interfaced with s mobile communication base station to receive a mobile communication signal realized as a RF signal from the mobile communication base station or it may be connected with a main hub unit (MHU) of the dual band in building system via an optical cable to receive a mobile communication signal realized as an optical signal from the main hub unit (MHU). The master unit (MU) 210 may be connected with the first to eighth expansion units (EU) 221 to 228 via UTP cables, respectively, in a cascade type.

The master unit (MU) 210 may separate payload from the internet signal via a fast Ethernet PHY chip and compress the mobile communication signal based on a compression algorithm selected for 1 Gbps transmission, to multiplex the internet signal and the mobile communication signal to an IEEE802.3 GMII standard gigabit Ethernet frame. The master unit (MU) 210 may insert a data communication channel (DCC) to the gigabit Ethernet frame and transmit the gigabit Ethernet frame having the DCC inserted therein to the remote units (RU) 231 to 236 via the expansion units (EU) 221 to 228.

The master unit (MU) 210 may control one or more of the first to eighth expansion units (EU) 221 to 228 and the first to sixty-fourth remote units (RU) 236 to be supplied an electric power via Power Over Ethernet (POE).

The first to eighth expansion units (EU) 221 to 228 may be connected with the master unit (MU) 210 via UTP cables, respectively. The first to eighth expansion units (EU) 221 to 228 may demultiplex the gigabit Ethernet frame received from the master unit (MU) 210 to a mobile communication signal and an internet signal.

The first to eighth expansion units (EU) 221 to 228 may re-multiplex the demultiplexed mobile communication and internet signals to a gigabit Ethernet frame and transmit the re-multiplexed gigabit Ethernet frame to the first to sixty-fourth remote units (RU) 231 to 236. In other words, the degraded signal of the gigabit Ethernet frame signal transmitted to the first expansion unit (EU) 221 from the master unit (MU) 210 may be regenerated by the first expansion unit (EU) 221. Accordingly, the gigabit Ethernet frame signal may be transmitted to one of the units located in a more expanded distance by the first to eighth remote units (RU) 231 to 232 and the second expansion unit (EU).

The first to eighth expansion units (EU) 221 to 228 may be directly connected with the switching hub 201 via UTP cables. In this instance, the first to eighth expansion units (EU) 221 to 228 may enable the internet signal received from the switching hub 201 to be provided in the gigabit Ethernet frame received from the master unit (MU) 210 and they may transmit the gigabit Ethernet frame having the internet signal to another expansion unit (EU) or the remote units (RU).

The first to sixty-fourth remote units (RU) 231 to 236 may be connected with the first to eighth expansion units 221 to 228 via UTP cables, respectively. The first to sixty-fourth remote units (RU) 231 to 236 may receive the gigabit Ethernet frame from the first to eighth expansion units (EU) 221 to 228 and demultiplex the gigabit Ethernet frame to the mobile communication signal and the internet signal. After that, the first to sixty-fourth remote units (RU) 231 to 236 may control the internet signal to be transmitted to an internet terminal and the mobile communication signal to be transmitted to a mobile communication terminal.

The first to sixty-fourth remote units (RU) 231 to 236 may transmit the demultiplexed internet signal from the gigabit Ethernet frame to the internet terminal via a fast Ethernet PHY chip in a fast Ethernet format.

The first to sixty-fourth remote units (RU) 231 to 236 may restore the compression of the demultiplexed mobile communication signal from the gigabit Ethernet frame. In other words, the compression of the mobile communication signal compressed and transmitted by the master unit (MU) 210 may be restored based on a restoration algorithm corresponding to the compression algorithm of the master unit (MU) 210.

The first to sixty-fourth remote units (RU) 231 to 236 may restore system characteristic degrading of the mobile communication signal via a digital down converter (DDC) and a digital up converter (DUC). In other words, the first to sixty-fourth remote units (RU) 231 to 236 may improve the system characteristics degraded by the compression and transmission of the mobile communication signal via the digital converter (DDC) and the digital up converter (DUC).

In addition, the first to sixty-fourth remote units (RU) 231 to 236 may perform control for the state and operation of the master unit (MU) 210 via the data communication channel (DCC) inserted in the gigabit Ethernet frame. In other words, the states or operations of the first to sixty-fourth remote units (RU) 231 to 236 may be controlled by the master unit (MU) 210.

A forward link of the integrated repeater system according to the embodiment shown in FIG. 2 is described. In contrast, a reverse link of the integrated repeater system according to the embodiment of the invention will be described as follows.

First to sixty-fourth remote units (RU) 231 to 236 may multiplex an internet signal received from the internet terminal and a mobile communication signal received from the mobile communication terminal to a gigabit Ethernet frame and transmit the multiplexed gigabit Ethernet frame to first to eighth expansion units (EU) 221 to 228 via UTP cables.

The first to sixty-fourth remote units (RU) 231 to 236 may separate payload from the internet signal via a fast Ethernet PHY chip, and they may compress the mobile communication signal based on a compression algorithm selected for 1 Gbps transmission and multiplex the internet signal and the mobile communication signal to IEEE802.3 GMII standard gigabit Ethernet frame.

The first to eighth expansion units (EU) 221 to 228 may demultiplex the gigabit Ethernet frame received from each of the first to sixty-fourth remote units (RU) 231 to 236 to the mobile communication signal and the internet signal. The first to eighth expansion units (EU) 221 to 228 may transmit re-multiplex the demultiplexed mobile communication and internet signals to the gigabit Ethernet frame to transmit the re-multiplexed gigabit Ethernet frame to the master unit (MU) 210. The master unit (MU) 210 may demultiplex the gigabit Ethernet frame received from each of the first to eighth expansion units (EU) 221 to 228 via the UTP cables to the mobile communication signal and the internet signal. After that, the master unit (MU) 210 may control the internet signal to be transmitted to a switching hub 201 and the mobile communication signal to be transmitted to a dual band in building system 202 or a RF repeater 203.

The master unit (MU) 210 may transmit the demultiplexed internet signal from the gigabit Ethernet frame to the switching hub 201 via a fast Ethernet PHY chip in a fast Ethernet format. Also, the master unit (MU) 210 may restore the compression of the mobile communication signal via the demultiplexed remote unit (RU) from the gigabit Ethernet frame based on a selected restoration algorithm. The master unit (MU) 210 may restore system character degrading of the mobile communication signal via a digital down converter (DDC) and a digital up converter (DUC) and transmit the system characteristic degrading restored mobile communication signal to the dual band in building system 202 or the RF repeater 203.

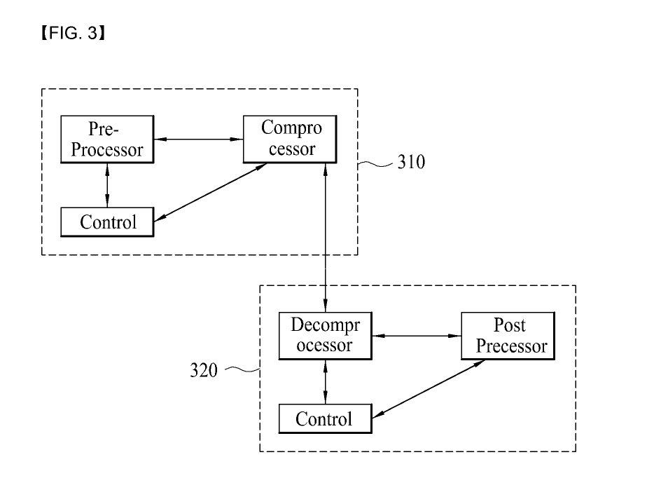

FIG. 3 is a block view illustrating the compression algorithm of the signal compressed and transmitted according to an embodiment of the invention.

According to this embodiment, the gigabit Ethernet frame signal transmitted to the expansion unit or the remote unit from the master unit (MU) may be compressed and transmitted based on a compression algorithm shown in FIG. 3. A block referenced to as “310” shown in FIG. 3 may be a compression algorithm of the unit performing compression and another block referenced to as “320” may be a compression algorithm of the unit releasing the compression.

In the block 310, a compressor may have an optimal performance when the signal has a low pass characteristic and a preprocessor may transform a signal sampled to have a low-pass and measure a noise floor, bandwidth, center frequency of the sampled signal. The preprocessor may report the measured signal characteristics to a control block and remove a bit corresponding to noise of each sample of the sampled input signal, to enhance the compression.

In the block 310, the control block may transmit preprocessor control parameters to the preprocessor and transmit compressor control parameters to the compressor.

In the block 310, the output of the compressor may generate a compressed signal and it is determined whether the compressor satisfies a compressibility specified by a user. When the compressor fails to satisfy the compressibility based on the result of the determination, a desired compressibility can be satisfied by feedback parameter or parameter change of the preprocessor. The compressor may transmit compression measurements or estimates to the control block and generate a header of information required by the compression.

In the block 320, a post processor may perform a restoration function for a characteristic of a frequency before compressing a sampled input signal. A pre-processor is employed to remove LSB of the sampled input signal and a post-processor is employed to restore the removed LSB.

In a block 320, a decompression may restore header information from the compressed signal. The header may include a center frequency of an input signal, a noise floor of the input signal, signal-to-noise ratio (SNR), LSB shift, a bandwidth and a modified sampling rate of the input signal.

When a compression mode is lossless, original sample input data may be generated as desamplified data. When a compression mode is lossy, the output oriented to original sample input data based on a compression ratio or SNR may be generated.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An integrated repeater system comprising:
a master unit (MU) to multiplex and transmit a first signal received from a first equipment and a second signal received from a second equipment to a frame usable for an Ethernet PHY chip; and
a remote unit (RU) to demultiplex the frame received from the master unit to the first signal and the second signal and to control the first signal to be transmitted to a first terminal and the second signal to be transmitted to a second terminal.

2. The integrated repeater system according to claim 1, wherein each of the first and second equipments is a dual band in building system, a mobile communication base station, a DMB repeater, a sensor or a switching hub, and
each of the first and second signals is one of a mobile communication signal, a DMB signal, a sensing signal or an internet signal, and
each of the first and second terminals is one of a mobile communication terminal, an internet terminal, a DMB terminal or a server.

3. The integrated repeater system according to claim 1, wherein when the first equipment is a dual band in building system and the second equipment is a switching hub and the first signal is a mobile communication signal and the second signal is an internet signal and the first terminal is a mobile communication terminal and the second terminal is an internet terminal, the master unit is RF-interfaced with a mobile communication base station and receives a mobile communication signal realized as a RF signal from the mobile communication base station or the master unit is connected with a main hub unit (MHU) via an optical cable and receives a mobile communication signal realized as an optical signal from the main hub unit (MHU).

4. The integrated repeater system according to claim 1, wherein when the first equipment is a mobile communication base station and the second equipment is a switching hub and the first signal is a mobile communication signal and the second signal is an internet signal and the first terminal is a mobile communication terminal and the second terminal is an internet terminal, the master unit separates payload from the internet signal via a fast Ethernet PHY chip and compresses the mobile communication signal based on a compression algorithm selected for 1 Gbps transmission and multiplexes the internet signal and the mobile communication signal to a IEEE802.3 GMII standard gigabit Ethernet frame and inserts a data communication channel (DCC) to the gigabit Ethernet frame, to transmit the gigabit Ethernet frame having the DCC inserted therein to the remote unit.

5. The integrated repeater system according to claim 1, wherein the master unit controls the remote unit to be supplied an electric power via Power Over Ethernet (POE).

6. The integrated repeater system according to claim 1, wherein when the first equipment is a mobile communication base station and the second equipment is a switching hub and the first signal is a mobile communication signal and the second signal is an internet signal and the first terminal is a mobile communication terminal and the second terminal is an internet terminal, the remote unit transmits the demultiplexed internet signal from the frame to the internet terminal via a fast Ethernet PHY chip in a fast Ethernet format.

7. The integrated repeater system according to claim 4, wherein the remote unit restores the compression of the demultiplexed mobile communication signal performed by the master unit based on a selected restoration algorithm, to restore system characteristic degrading of the mobile communication signal via a Digital Down Converter (DDC) and a Digital Up Converter (DUC), and controls a state and an operation of the master unit via the data communication channel (DCC) inserted in the gigabit Ethernet frame.

8. The integrated repeater system according to claim 1, wherein the frame useable for the Ethernet PHY chip is a media independent interface (MII) comprising GMII, RMII, RGMII, SGMII and XGMII.

9. The integrated repeater system according to claim 8, wherein when the frame useable for the Ethernet PHY chip is a gigabit Ethernet frame, the gigabit Ethernet frame is multiplexed to have IEEE802.3 GMII Standard.

10. An integrated repeater system comprising:
a master unit (MU) to multiplex and transmit a first signal received from a first equipment and a second signal received from a second equipment to a frame usable for an Ethernet PHY chip; and
an expansion unit (EU) to demultiplex the gigabit Ethernet frame received from the master unit to the first signal and the second signal and to re-multiplex and transmit the demultiplexed first and second signals to the gigabit Ethernet frame; and
a remote unit to receive the gigabit Ethernet frame from the expansion unit (EU), and to demultiplex the gigabit Ethernet frame to the first signal and the second signal to control the first signal to be transmitted to a first terminal and the second signal to be transmitted to a second terminal.

11. The integrated repeater system according to claim 10, wherein each of the first equipment and the second equipment is a dual band in building system, a mobile communication base station, a DMB repeater, a sensor or a switching hub, and
each of the first and second signals is one of a mobile communication signal, a DMB signal, a sensing signal or an internet signal, and
each of the first and second terminals is one of a mobile communication terminal, an internet terminal, a DMB terminal or a server.

12. The integrated repeater system according to claim 10, wherein when the first equipment is a dual band in building system and the second equipment is a switching hub and the first signal is a mobile communication signal and the second signal is an internet signal and the first terminal is a mobile communication terminal and the second terminal is an internet terminal, the master unit is RF-interfaced with a mobile communication base station and receives a mobile communication signal realized as a RF signal from the mobile communication base station or the master unit is connected with a main hub unit (MHU) via an optical cable and receives a mobile communication signal realized as an optical signal from the main hub unit (MHU).

13. The integrated repeater system according to claim 10, wherein when the first equipment is a mobile communication base station and the second equipment is a switching hub and the first signal is a mobile communication signal and the second signal is an internet signal and the first terminal is a mobile communication terminal and the second terminal is an internet terminal, the master unit separates payload from the internet signal via a fast Ethernet PHY chip and compresses the mobile communication signal based on a compression algorithm selected for 1 Gbps transmission and multiplexes the internet signal and the mobile communication signal to a IEEE802.3 GMII standard gigabit Ethernet frame and inserts a data communication channel (DCC) to the gigabit Ethernet frame, to transmit the gigabit Ethernet frame having the DCC inserted therein to the remote unit.

14. The integrated repeater system according to claim 10, wherein the master unit controls at least one of the expansion unit (EU) and the remote unit to be supplied an electric power via Power Over Ethernet (POE).

15. The integrated repeater system according to claim 10, wherein when the first equipment is a mobile communication base station and the second equipment is a switching hub and the first signal is a mobile communication signal and the second signal is an internet signal and the first terminal is a mobile communication terminal and the second terminal is an internet terminal, the remote unit transmits the demultiplexed internet signal from the gigabit Ethernet frame to the internet terminal via a fast Ethernet PHY chip in a fast Ethernet format.

16. The integrated repeater system according to claim 13, wherein the remote unit restores the compression of the demultiplexed mobile communication signal performed by the master unit based on a selected restoration algorithm, to restore system characteristic degrading of the mobile communication signal via a digital down converter (DDC) and a digital up converter (DUC), and controls a state and an operation of the master unit via the data communication channel (DCC) inserted in the gigabit Ethernet frame.

17. The integrated repeater system according to claim 10, wherein the expansion unit (EU) transmits the multiplexed gigabit Ethernet frame from the first signal and the second signal to another expansion (EU).

18. The integrated repeater system according to claim 10, wherein when the first equipment is a mobile communication base station and the second equipment is a switching hub and the first signal is a mobile communication signal and the second signal is an internet signal and the first terminal is a mobile communication terminal and the second terminal is an internet terminal, the expansion unit (EU) is connected with the switching hub via an UTP cable and enables an internet signal received from the switching hub to be provided in the gigabit Ethernet frame received from the master unit to transmit the gigabit Ethernet frame having the internet signal to another expansion unit (EU) or the remote unit.

19. The integrated repeater system according to claim 10, wherein the remote unit multiplexes the first signal received from the first terminal and the second signal received from the second terminal to a gigabit Ethernet frame and transmits the multiplexed gigabit Ethernet frame to the expansion unit (EU), and
the expansion unit (EU) demultiplexes the gigabit Ethernet frame received from the remote unit to the first signal and the second signal and multiplexes the re-multiplexed first and second signals to the gigabit Ethernet frame to transmit the re-multiplexed gigabit Ethernet frame to the master unit, and
the master unit demultiplexes the gigabit Ethernet frame received from the expansion unit (EU) via an UTP cable to the first signal and the second signal and controls the first signal to be transmitted to the first equipment and the second signal to be transmitted to the second equipment.

20. The integrated repeater system according to claim 19, wherein when the first equipment is a mobile communication base station and the second equipment is a switching hub and the first signal is a mobile communication signal and the second signal is an internet signal and the first terminal is a mobile communication terminal and the second terminal is an internet terminal, the remote unit separates payload from the internet signal via a fast Ethernet PHY chip and compresses the mobile communication signal based on a compression algorithm selected for 1 Gbps transmission and multiplexes the internet signal and the mobile communication signal to a IEEE802.3 GMII standard gigabit Ethernet frame, and
the master unit transmits the demultiplexed internet signal from the gigabit Ethernet frame to the switching hub via a fast Ethernet PHY chip in a fast Ethernet format and restores the compression of the demultiplexed mobile communication signal via the master unit based on a selected restoration algorithm and restores system characteristic degrading of the mobile communication signal via a digital down converter (DDC) and a digital up converter (DUC) to transmit the mobile communication signal to the dual band in building system.
